(19) United States
(12) Patent Application Publication
(10) Pub. No.: US 2005/0227134 A1
(43) Pub. Date: Oct. 13, 2005

(54) Offset interconnect for a solid oxide fuel cell and method of making same

(75) Inventor: Dien Nguyen, San Jose, CA (US)

Correspondence Address: FOLEY AND LARDNER;SUITE 500, 3000 K STREET NW, WASHINGTON, DC, 20007, US

(73) Assignee: Ion American Corporation

(21) Appl. No.: 10/822,707

(22) Filed: Apr. 13, 2004

(51) Int. Cl. H01M 8/10; H01M 2/00; H01M 2/14; B23P 19/00

(52) U.S. Cl. 429/32; 429/38; 429/39; 429/33; 29/745; 29/730; 29/623.3

(57) ABSTRACT

An interconnect for a solid oxide fuel cell includes a non-ionically and non-electrically conductive ceramic gas separator plate comprising at least two ceramic layers, a plurality of first vias extending through the first separator plate ceramic layer but not through the second separator plate ceramic layer and a plurality of second vias extending through the second separator plate ceramic layer but not through the first separator plate ceramic layer. The second vias are offset from the first vias. The interconnect also includes a plurality of electrically conductive first fillers located in the plurality of first vias and a plurality of electrically conductive second fillers located in the plurality of second vias. Each of the plurality of first fillers is electrically connected to at least one second filler.

### BACKGROUND OF THE INVENTION

The present invention is generally directed to fuel cell components and more specifically to interconnects for solid oxide fuel cells.

Fuel cells are electrochemical devices which can convert energy stored in fuels to electrical energy with high efficiencies. One type of high temperature fuel cell is a solid oxide fuel cells which contains a ceramic (i.e., a solid oxide) electrolyte, such as a yttria stabilized zirconia (YSZ) electrolyte. One component a planar solid oxide fuel cell stack or system is the so called gas separator plate that separates the individual cells in the stack. The gas separator plate separates fuel, such as hydrogen or a hydrocarbon fuel, flowing to the anode of one cell in the stack from oxidant, such as air, flowing to a cathode of an adjacent cell in the stack. Frequently, the gas separator plate is also used as an interconnect which electrically connects the anode electrode of one cell to a cathode electrode of the adjacent cell. In this case, the gas separator plate which functions as an interconnect is made of an electrically conductive material. This gas separator plate preferably has the following characteristics: it does not conduct ions, it is non-permeable to the fuel and oxidant, it is chemically stable in both the fuel and oxidant environment over the entire operating temperature range, it does not contaminate either the electrodes or the electrolyte, it is compatible with the high temperature sealing system, it has a Coefficient of Thermal Expansion (CTE) that closely matches that of the selected electrolyte, and it has a configuration that lends itself to low cost at high volumes.

In the prior art, gas separator plates which function as interconnects have been developed using tailored metal alloys and electrically conductive ceramics. These approaches have not been completely satisfactory. The tailored metal alloy approach meets all the desired characteristics except that it is limited to a matching CTE that is only within about 10% of the solid oxide electrolyte. A more closely matched CTE can be accomplished by sacrificing the chemical compatibility of the interconnect with the electrodes/electrolyte. As a result of this CTE limitation, the area of the cell is limited in order to avoid stressing the electrolyte beyond its capability. Additionally, the seals are more difficult to be reliably produced and the electrolyte thickness must be proportionally thicker to have the strength to counteract the minor CTE mismatch.

There are two types of prior art ceramic gas separator plate interconnects. The first type uses an electrically conductive ceramic material. However, these electrically conductive ceramics are expensive and difficult to fabricate, their chemical compatibility with the electrodes is lower than desired and the CTE mismatch of these ceramics with the electrolyte remains higher than desired.

The second type of ceramic gas separator plate comprises a CTE matched, non-electrically conductive ceramic material with multiple through vias filled with an electrically conductive material. This approach solves the CTE mismatch, the chemical incompatibility and the high volume cost difficulty problems of the first type of ceramic separator plate. However, this configuration is susceptible to undesirable cross interconnect reactant permeability (i.e., leakage of the fuel and oxidant through the separator plate).

### BRIEF SUMMARY OF THE INVENTION

One preferred aspect of the present invention provides an interconnect for a solid oxide fuel cell, comprising a non-ionically and non-electrically conductive ceramic gas separator plate comprising at least two ceramic layers, a plurality of first vias extending through the first separator plate ceramic layer but not through the second separator plate ceramic layer and a plurality of second vias extending through the second separator plate ceramic layer but not through the first separator plate ceramic layer, wherein the second vias are offset from the first vias. The interconnect further comprises a plurality of electrically conductive first fillers located in the plurality of first vias, and a plurality of electrically conductive second fillers located in the plurality of second vias. Each of the plurality of first fillers is electrically connected to at least one second filler.

Another preferred aspect of the present invention provides an interconnect for a solid oxide fuel cell, comprising a non-ionically and non-electrically conductive ceramic gas separator plate comprising opposing major surfaces and an electrically conductive interconnecting body located inside the ceramic gas separator plate. The interconnect further comprises a plurality of first vias which extend from the first major surface of the ceramic gas separator plate up to the interconnecting body, and a plurality of second vias which extend from the second major surface of the ceramic gas separator plate up to the interconnecting body, wherein the second vias are offset from the first vias. The interconnect further comprises a plurality of electrically conductive first fillers located in the plurality of first vias, and a plurality of electrically conductive second fillers located in the plurality of second vias. The first fillers are exposed below, in or over the first major surface of the gas separator plate and the second fillers are exposed below, in or over the second major surface of the gas separator plate. The first and the second fillers are located in electrical contact with the interconnecting body.

Another preferred aspect of the present invention provides a method of making an interconnect for a solid oxide fuel cell, comprising providing at least two non-ionically and non-electrically conductive ceramic layers, forming a plurality of first vias extending through the first ceramic layer, and forming a plurality of second vias extending through the second ceramic layer. The method further comprises laminating the first ceramic layer and the second ceramic layer to form a ceramic gas separator plate. The first vias are offset from the second vias in the laminated layers. The method further comprises forming a plurality of electrically conductive first fillers in the plurality of first vias, and forming a plurality of electrically conductive second fillers in the plurality of second vias. Each of the plurality of first fillers is electrically connected to at least one second filler.

### BRIEF DESCRIPTION OF THE DRAWINGS

FIGS. 1, 2 and 3 are schematic side cross sectional views of offset interconnects for solid oxide fuel cells according to preferred embodiments of the present invention.

FIG. 4 is a schematic side cross sectional view of a solid oxide fuel cell stack incorporating the offset interconnects of the preferred embodiments of the present invention.

FIGS. 5 and 6 are schematic side cross sectional views of steps in a method of making the interconnects of the preferred embodiments of the present invention.

FIGS. 7 and 8 are top views of steps in a method of making the interconnects of the preferred embodiments of the present invention.

### DETAILED DESCRIPTION OF THE PREFERRED EMBODIMENTS

The present inventor has realized that an interconnect comprising a ceramic gas separator plate made from a CTE matched, non-electrically conductive ceramic material but without vias extending through the gas separator plate, reduces or eliminates the undesirable cross interconnect reactant permeability (i.e., leakage of the fuel and oxidant through the separator plate) and still meets all of the other desired characteristics of a functional interconnect.

The interconnect contains a non-ionically and non-electrically conductive ceramic gas separator plate that contains at least two ceramic layers. A plurality of first vias extend through the first separator plate ceramic layer but not through the second separator plate ceramic layer. A plurality of second vias extend through the second separator plate ceramic layer but not through the first separator plate ceramic layer. The second vias are offset from the first vias. The term “offset” means that when the vias are viewed normal to the major surfaces of the gas separator plate, the first and the second vias do not overlap. In other words, the first and second vias are arranged such that there is no imaginary straight line that extends through both a first and a second via from the upper to the lower major surface of the gas separator plate in a direction normal to the major surfaces of the gas separator plate (i.e., in a direction parallel to the gas separator plate thickness).

A plurality of electrically conductive first fillers are located in the plurality of first vias. A plurality of electrically conductive second fillers are located in the plurality of second vias. Each of the plurality of first fillers is electrically connected to at least one second filler.

This offset via configuration has several advantages compared to the prior art configuration. It should be noted that these advantages are illustrative only and should not be considered limiting on the scope of the claims. The offset via configuration allows the interconnect to be incorporated into a gas separator plate without using vias that extend through the entire gas separator plate. This also allows the gas separator plate to be made from a non-ionically and non-electrically conductive ceramic material which is CTE matched to the electrolyte material without increased cross interconnect reactant permeability. The offset via configuration also allows the active area of the individual cells to be increased to further decrease costs and to simplify the fuel cell stack sealing configuration. Additionally, thinner and/or lower strength electrolytes can be used with a CTE matched ceramic gas separator plate, thus increasing the power density of the cells which also leads to a lowering of costs per kW. Furthermore, when the ceramic gas separator plate material has a CTE that is within about 1% of the solid oxide electrolyte material, greatly increases the ability to rapidly thermally cycle the solid oxide stack. Because of the separation of the top and bottom fillers that fill the offset vias, the size of the top vias and the size of the bottom vias may be different from each other, as long as they behave the same electrically. The ability to optimize via sizes may be advantageous for reducing material costs in mass production of the interconnect.

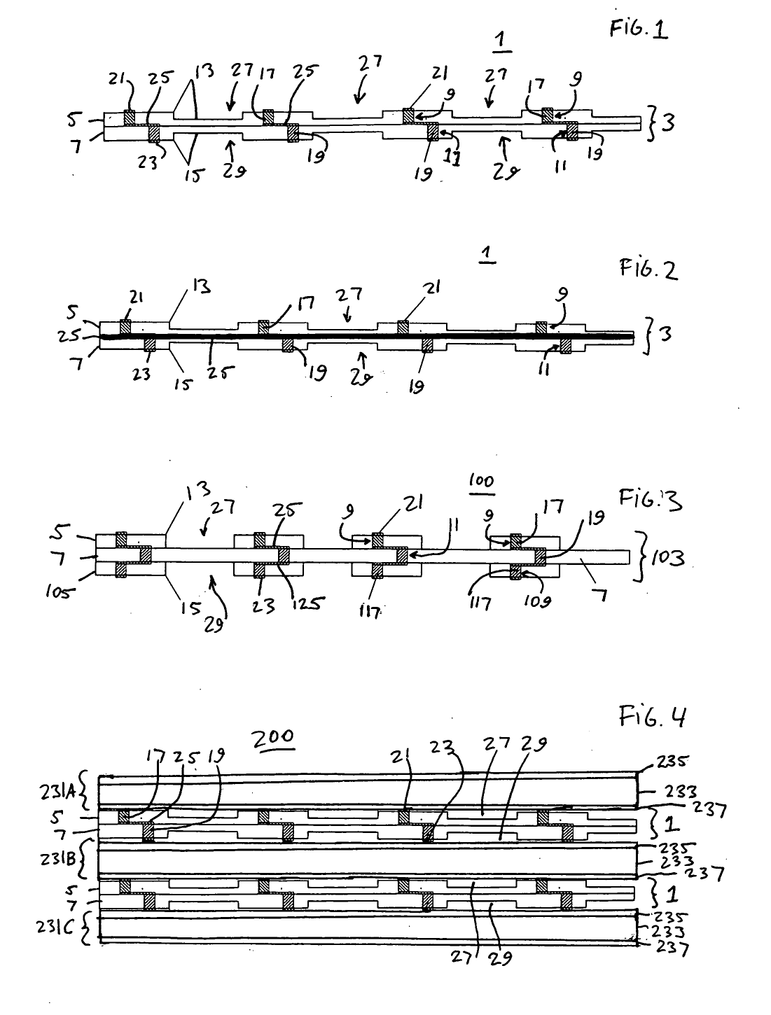

The following preferred embodiments of the offset via interconnect should not be considered to be limiting on the scope of the claims. FIG. 1 shows a side cross sectional view of an interconnect 1 according to the first preferred embodiment of the invention.

The interconnect 1 contains a non-ionically and non-electrically conductive ceramic gas separator plate 3. The gas separator plate 3 contains two or more ceramic layers. For example, as shown in FIG. 1, the gas separator plate contains two ceramic layers 5 and 7. The layers 5, 7 may have any suitable thickness depending on the overall size of the fuel cell stack and the gas separator plate 3. The layers 5, 7 may comprise ceramic tape cast layers for example. For example, the layers 5, 7 may have a thickness of about 0.1 to about 0.25 inches. However, other thicknesses may be used for large and micro fuel cell stacks.

The first vias 9 extend through the first separator plate ceramic layer 5 but not through the second separator plate ceramic layer 7. The second vias 11 extend through the second separator plate ceramic layer 7 but not through the first separator plate ceramic layer 5. As shown in FIG. 1, the second vias are offset from the first vias in a direction parallel to the major surfaces 13, 15 of the gas separator plate 3. The major surfaces 13, 15 are separated from each other in the separator plate 3 thickness direction and the ceramic layers 5, 7 are stacked in the separator plate 3 thickness direction. The vias 9, 11 may have any suitable shape. For example, the vias 9, 11 may have circular, oval, polygonal and other suitable regular or irregular cross sectional shapes when the cross section is taken parallel to the major surfaces 13, 15 of the gas separator plate. The vias may have any suitable size, such as about 0.1 to about 0.2 inches, for example. However, larger vias may be used in large fuel cell stacks with a large current passing through the interconnect and smaller vias may be used in micro fuel cells. Preferably, the vias 9 are offset from vias 11 by a distance that equals to about one to about three via diameters when measured from center of via 9 to center of adjacent via 11. However, other offset values may be used as desired.

A plurality of electrically conductive first fillers 17 are located in the plurality of first vias 9. A plurality of electrically conductive second fillers 19 are located in the plurality of second vias 11. Each filler 17, 19 may have any suitable shape and the filler cross sectional shape is the same as that of the respective vias 9, 11 when the cross section is taken parallel to the major surfaces 13, 15 of the gas separator plate.

The first fillers 17 are exposed below, in or over the first major surface 13 of the separator plate 3 and the second fillers 19 are exposed below, in or over the second major surface 15 of the separator plate 3. For example, the fillers 17, 19 may extend out of the respective vias 9, 11, such that the fillers 17, 19 protrude from the respective major surfaces 13, 15 of the separator plate 3. Alternatively, the fillers 17, 19 may be exposed in the respective vias 9, 11 below or in surfaces 13, 15. In this configuration, contact pads 21, 23 are preferably located on the fillers 17 and 19 such that the contact pads 21, 23 protrude from the major surfaces 13, 15 of the separator plate 3. The contact pads 21, 23 may be made of a different electrically conductive material than the fillers 17, 19. For example, the cathode contact pad 21 may be made of the same or similar material as the cathode of a fuel cell and the anode contact pad 23 may be made of the same or similar material as the anode of the fuel cell.

Each of the plurality of first fillers 17 is electrically connected to at least one second filler 19. Preferably, the interconnect 1 also contains an electrically conductive interconnecting body 25 located between the first separator plate ceramic layer 5 and the second separator plate ceramic layer 7. The interconnecting body 25 contacts at least one first filler 17 and at least one second filler 19 to electrically connect at least one first filler 17 to at least one second filler 19.

The interconnecting body 25 may have any suitable shape to electrically connect at least one first filler 17 to at least one second filler 19. For example, the interconnecting body 25 may comprise a layer, a sheet, a screen (such as a woven screen), a foil, a platelet, a strip, a wire or an expanded metal. In one exemplary configuration, the interconnecting body 25 comprises a platelet, a strip or a wire which electrically connects each of respective first fillers to a single respective second filler. As shown in FIG. 1, each of a plurality of conductive strips 25 connects each first filler 17 to one respective second filler 19.

Alternatively, the interconnecting body comprises a continuous or perforated layer, sheet, screen or foil 25 which extends substantially parallel to gas separator plate surfaces 13, 15 and which electrically connects each of the plurality of first fillers 17 to each of the plurality of second fillers 19, as shown in FIG. 2. In other words, each first filler 17 is electrically connected to many second fillers 19 and vice versa. The interconnecting body 25 contacts a plurality of first 17 and second 19 fillers.

The preferred electrically conductive material configuration comprises electrically conductive, cylindrical fillers 17, 19 located in offset cylindrical blind holes 9, 11 perpendicular to the major surfaces of the gas separator plate and connected at their blind end by a thin sheet of electrically conductive material 25 located parallel to the interconnect surface.

The gas separator plate 3 preferably contains gas flow grooves 27, 29 located in the respective first 13 and second 15 major surfaces of the separator plate 3. The grooves 27 and 29 may be parallel to each other as shown in FIG. 1. Alternatively, the grooves may be perpendicular to each other for cross gas flow on opposite sides of the gas separator plate. Of course, the grooves 27 and 29 may extend in any direction between parallel and perpendicular from each other if desired. Preferably, the vias 9, 11 are located in the portions of the separator plate 3 that do not contain the grooves 27, 29. In other words, the fillers 17, 19 and/or contact pads 21, 23 do not extend out of the portions of the major surfaces 13, 15 of the separator plate 3 that contain the grooves 27, 29.

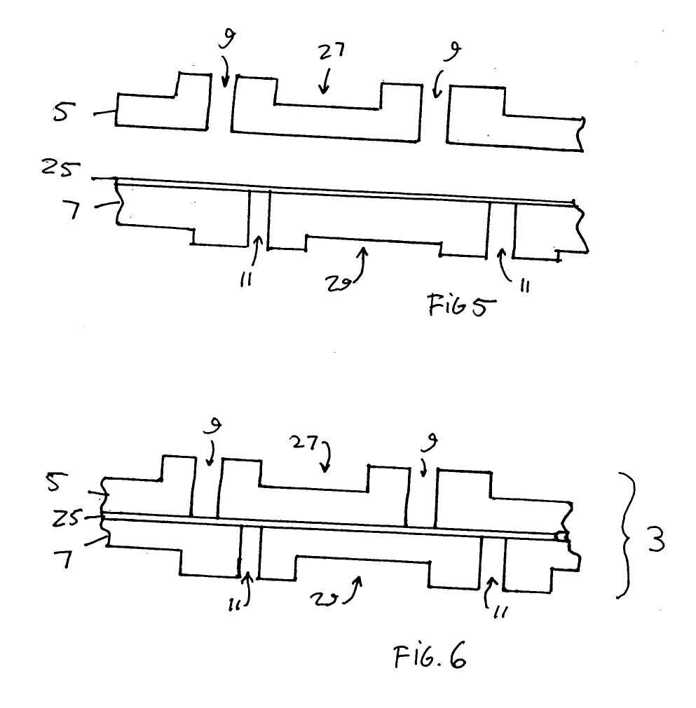

FIG. 3 illustrates an interconnect 100 according to the second preferred embodiment. The gas separator plate 103 of the interconnect 100 also contains a third separator plate ceramic layer 105. Thus, the second separator plate ceramic layer 7 is located between the first 5 and the third 105 separator plate ceramic layers. A plurality of third vias 109 extend through the third separator plate ceramic layer 105 but not through the first 5 or second 7 separator plate ceramic layers. As shown in FIG. 3, the third vias 109 are offset from the second vias 11 in the second layer 7. This offset prevents or reduces cross interconnect reactant permeability. Thus, the third vias 109 in the third layer are not necessarily offset from the first vias 9 in the first layer 5, as shown in FIG. 3.

A plurality of electrically conductive third fillers 117 are located in the plurality of third vias 109. Each of the plurality of third fillers 117 is electrically connected to at least one second filler 19. A second electrically conductive interconnecting body 125 is located between the second separator plate ceramic layer 7 and the third separator plate ceramic layer 105. The second interconnecting body 125 contacts at least one second filler 19 and at least one third filler 117 to electrically connect at least one second filler 19 to at least one third filler 117. The second interconnecting body 125 may have the same or different shape from the first interconnecting body (i.e., it may have a layer, a sheet, a screen, a foil, a platelet, a strip, a wire or an expanded metal shape). The second interconnecting body 125 may connect individual fillers 19, 117 to each other or it may connect plural fillers 19 to plural fillers 117 similar to the configuration shown in FIG. 2.

A conductive path is formed from one major surface 13 to the other major surface 15 of the gas separator plate 3 through the first conductive fillers 17, the first interconnecting body 25, the second conductive fillers 19, the second interconnecting body 125 and the third conductive fillers 117. The first 17 and third 117 fillers extend out of the respective separator plate surface 13, 15 or the contact pads 21, 23 are formed on respective fillers 17, 117, as shown in FIG. 3. It should be noted that the interconnect 100 may have more than three layers by repeating the structure shown in FIG. 3.

FIG. 4 illustrates a solid oxide fuel cell stack 200 incorporating a plurality of interconnects 1 or 100 of the first or the second embodiment and a plurality of solid oxide fuel cells 231. Each solid oxide fuel cell 231 comprises a plate shaped fuel cell comprising a ceramic electrolyte 233, an anode 235 located on a first surface of the electrolyte and a cathode 237 located on a second surface of the electrolyte. The fuel cells also contain various contacts, seals and other components which are omitted from FIG. 4 for clarity.

Each interconnect 1 shown in FIG. 4 is located between adjacent fuel cells 231 in the stack. Each first filler 17 in each interconnect 1 is electrically connected to an adjacent cathode 237 of a first adjacent fuel cell 231A. Each second filler 19 in each interconnect 1 is electrically connected to an adjacent anode 235 of a second adjacent fuel cell 231B, such that each interconnect 1 electrically connects an anode 235 of a first fuel cell 231A and a cathode 237 of an adjacent second fuel cell 231B. If cathode 21 and anode 23 contact pads are present, then these pads are located in electrical contact with and between the respective fillers 17, 19 and the respective electrodes 237, 235 of the fuel cells 231, as shown in FIG. 4. It should be noted that the stack 200 shown in FIG. 4, may be oriented upside down or sideways from the exemplary orientation shown in FIG. 4. Furthermore, the thickness of the components of the stack 200 is not drawn to scale or in actual proportion to each other, but is magnified for clarity.

Preferably, the ceramic gas separator plate 3 comprises ceramic material layers having a coefficient of thermal expansion which differs by about one percent or less from a coefficient of thermal expansion of the ceramic electrolyte 233 material of the fuel cells 231. In other words, the layers 5, 7 of the separator plate are made of a ceramic material which is CTE matched to the material of the ceramic electrolyte.

While any suitable materials may be used, preferably, the electrolyte comprises any suitable yttria stabilized zirconia and the ceramic gas separator plate comprises a blend of alumina and yttria stabilized zirconia. The separator plate ceramic material preferably comprises an amount of alumina sufficient to render the ceramic non-ionically conductive, but preferably not exceeding the amount which would render the gas separator plate ceramic material to be non-CTE matched with the electrolyte. CTE matched and non-ionically conductive blends of yttria stabilized zirconia and ceramics other than alumina may also be used.

The fillers 17, 19 and 117 and the interconnecting bodies 25, 125 may comprise any suitable electrically conductive materials. These materials may be selected from electrically conductive ceramics, such as strontium doped lanthanum manganite (LSM) or strontium doped lanthanum chromite (LSC), or metals or metal alloys, such as silver palladium alloys, chromia forming metals, and/or platinum. If platinum is used, a small amount of it may be mixed with other conductive materials, such as silver and palladium alloys and/or with glass, in order to reduce the cost of the interconnect.

The interconnecting body may comprise the same or different material from that of the fillers as desired. If desired, different fillers may comprise different materials. For example, the fillers which contact the anode may comprise the same or similar material to that of the anode, while the fillers which contact the cathode may comprise the same or similar materials to that of the cathode. Likewise, the contact pads 21, 23 may comprise the same or similar material to that of the electrode which they contact. For example, if the anode 235 comprises a nickel-YSZ cermet, then the filler 19 which contacts the anode and/or the anode contact pad 23 (if present) may comprise nickel, a nickel alloy or a nickel-YSZ cermet. If the cathode 237 comprises LSM, then the filler 17 which contacts the cathode and/or the cathode contact pad 21 (if present) may comprise LSM.

Thus, the preferred embodiments of the present invention provide an interconnect which comprises a gas separator plate having vias within non-electrically conductive YSZ containing ceramic layers and joining two or more such ceramic layers such that the vias are offset in the adjacent layers. An electrically conductive material is positioned within the vias and inside the gas separator plate, such as between the ceramic layers, to allow electron conductivity from one outside surface to the opposite outside surface of the gas separator plate while reducing or eliminating the undesired reactant permeability.

The interconnects 1, 100 of the preferred embodiment of the present invention may be made by any suitable method. A preferred method of making the interconnects 1, 100 includes providing at least two non-ionically and non-electrically conductive ceramic layers 5, 7, as shown in FIG. 5. Preferably, the layers 5, 7 comprise unsintered or “green” ceramic layers. Preferably, the layers 5, 7 are made by a ceramic tape casting method. For a micro sized fuel cell, the layers 5, 7 may be formed over a substrate by ceramic thin film or layer deposition methods, such as sputtering.

The gas flow grooves 27, 29 may be formed in the respective first 5 and second 7 ceramic layers at any suitable point in the process. For example, the grooves 27, 29 may be formed prior to sintering by any suitable green tape or sheet patterning method. Preferably, the grooves are formed prior to forming the vias 9, 11 in the layers 5, 7.

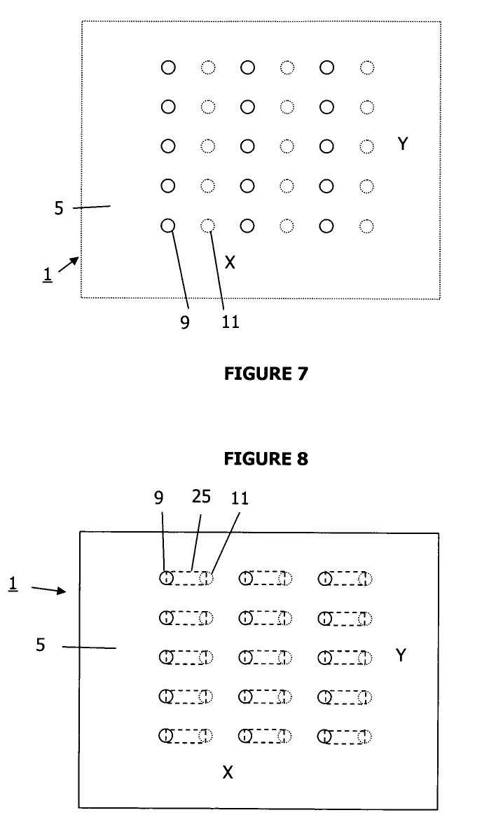

A plurality of first vias 9 are formed extending through the first ceramic layer 5. A plurality of second vias 11 are formed extending through the second ceramic layer 7. The vias 9, 11 may be formed by any suitable method, such as by punching holes in the green ceramic layers 5, 7. For micro sized fuel cells, the vias 9, 11 may be formed by microfabrication methods, such as photolithography (i.e., photoresist masking) and etching. FIG. 7 shows a top view of ceramic layer 5 with an exemplary arrangement of vias 9. The locations of vias 11 in ceramic layer 7 are shown as dashed lines.

The electrically conductive interconnecting body 25 is then formed on a surface of at least one of the first ceramic layer 5 and the second ceramic layer 7. For example, the interconnecting body 25 may be deposited as a thin sheet by spreading a conductive paste in desired locations on one or both ceramic layers 5, 7, such as by using screen or stencil printing techniques. Alternatively, the interconnecting body 25 may be deposited by thin film deposition methods, such as sputtering, dip coating or chemical vapor deposition. For micro sized fuel cells, the body 25 may be patterned by photolithography and etching or other microfabrication methods. The interconnecting body 25 may be formed before or after forming the vias 9, 11.

As shown in FIG. 6, after forming the interconnecting body 25, the first ceramic layer 5 and the second ceramic layer 7 are laminated such that the interconnecting body 25 is located between the first and the second ceramic layers. FIG. 8 shows a top view of the interconnect at this stage in the fabrication. Vias 11 in the underlying layer 7 and strip shaped interconnecting bodies 25 located between layers 5 and 7 are shown schematically by the dashed lines. Preferably, the layers 5, 7 are green or unsintered during lamination. The first ceramic layer 5 and the second ceramic layer 7 are laminated by placing one layer over the layer below to form the ceramic gas separator plate 3, such that the first vias 9 are offset from the second vias 11. Preferably, the layers 5, 7 are ceramic tape layers that are placed in contact with each other. Preferably, heat and/or pressure are also used to improve the lamination between the layers. For micro sized fuel cells, the first layer 5 is deposited on a substrate, the interconnecting body 25 is deposited on the first layer 5 and the second layer 7 is deposited on the interconnecting body.

Alternatively, the vias 9, 11 may be formed after laminating the layers 5 and 7, especially if the via formation method does not make holes in the interconnecting body 25. An example of such a via formation method is selective etching using an etching medium which selectively etches the ceramic layers but not the interconnecting body material.

The green laminated ceramic layers 5, 7 are then preferably sintered. Sintering or co-firing the laminated first and second ceramic layers forms an inseparable ceramic gas separator plate assembly 3. It should be noted that in the sintered gas separator plate, the boundary between layers 5, 7 may become obscured. Also, for ceramic layers deposited by some thin film deposition methods, sintering may not be necessary.

Optionally, to form the vias with more precision, several sheets of the same material may be sintered with precise features punched, and measured before and after sintering, to establish accurate shrinkage coefficient of the green tape. The shrinkage coefficient can then be used to precisely locate the connecting vias from one green ceramic layer to the adjacent layer.

As shown in FIGS. 1 and 2, following sintering, the vias 9, 11 are filled by forming a plurality of electrically conductive first fillers 17 in the plurality of first vias 9 and a plurality of electrically conductive second fillers 19 in the plurality of second vias 11. The fillers 17, 19 may be formed by selectively placing a conductive paste in the respective vias, such as by using screen or stencil printing techniques. For micro sized fuel cells, the fillers 17, 19 may be formed by thin film deposition methods, such as by selective electroplating or chemical vapor deposition on the interconnecting body 25 material exposed in the vias or by thin film deposition followed by etching. If present, the contact pads 21, 23 may then be formed on the fillers 17, 19.

Since the vias 9, 11 extend to the interconnecting body 25, which is exposed at the bottom of the vias, the interconnecting body contacts at least one first filler 17 and at least one second filler 19 to electrically connect at least one first filler to at least one second filler. Alternatively, the fillers 17, 19 may be formed prior to sintering the ceramic layers 5, 7, if desired.

To form the interconnect 100 of the second preferred embodiment, a third ceramic layer, a third set of vias, a third set of fillers and a second interconnect body are added to process. The process may be extended to form interconnects having more than three ceramic layers.

The interconnects 1, 100 are then incorporated into a solid oxide fuel cell stack by providing an interconnect between adjacent solid oxide fuel cells.

Thus, as described above, the blind vias are preferably punched out of the ceramic layers prior to sintering and filled with the conductive material fillers after sintering. This process of post filling the blind vias allows a broader choice of conductive materials to be used in the blind vias since the material does not undergo the high-temperature sintering process.

An example of the above described interconnect configuration was made from a blend of yttria stabilized zirconia with alumina as a non-conductive material, using a tape casting process. The electrically conductive material in the interconnect was platinum. To form the non-conductive ceramic body, three layers of the above YSZ-alumina composite green tape (unfired ceramic) were used. The thickness of each of the three fired layers was about 0.18 inches. The diameter of the vias was about 0.14 inches and the offset distance between the centers of the vias in adjacent layers was about 0.28 inches. Printed patterns of conductive ink material were deposited on both surfaces of the layers prior to laminating the layers together using pressure and heat to create the bonding between the layers. The component was shaped to its final outer green dimension before being sintered to final density and configuration.

Upon the completion of the filling and curing processes, the component was tested for electrical performance and hermeticity. For electrical performance, a 4-probe technique was used. Four electrical contacts were made to one set of connecting vias (two on each side of the component). One set of the opposing electrical contacts was connected to a current source to form a complete power circuit. The other set of opposing contacts was connected to a voltage measuring device such as a multimeter, for measuring a voltage drop across the interconnect due to the resistivity of the filler material. Since the resistivity of the filler in the via is inversely proportional to the cross section of the conduction path, which is the cross-sectioned area of the filler in the via, the electrical test may be used to select a desired via size to achieve a desired resistivity value of the interconnect. In the example, a resistivity of less than 0.1 ohms for a current in excess of 1 amp was measured.

To test for hermeticity, a dye penetrant was used determine the gross leakage across the exemplary interconnect. The dye penetrant was applied generously on one side of the interconnect, and kept present on the same surface for up to 48 hours. No dye material was detected on the opposite side at the end of the interconnect indicating that the component was sufficiently hermetic.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. An interconnect for a solid oxide fuel cell, comprising:
a non-ionically and non-electrically conductive ceramic gas separator plate comprising at least two ceramic layers;
a plurality of first vias extending through the first separator plate ceramic layer but not through the second separator plate ceramic layer;
a plurality of second vias extending through the second separator plate ceramic layer but not through the first separator plate ceramic layer, wherein the second vias are offset from the first vias;
a plurality of electrically conductive first fillers located in the plurality of first vias; and
a plurality of electrically conductive second fillers located in the plurality of second vias, wherein each of the plurality of first fillers is electrically connected to at least one second filler.

2. The interconnect of claim 1, further comprising an electrically conductive interconnecting body located between the first separator plate ceramic layer and the second separator plate ceramic layer, such that the interconnecting body contacts at least one first filler and at least one second filler to electrically connect at least one first filler to at least one second filler.

3. The interconnect of claim 2, wherein the interconnecting body is selected from a group consisting of a layer, a sheet, a screen, a foil, a platelet, a strip, a wire or an expanded metal.

4. The interconnect of claim 3, wherein the interconnecting body comprises a layer, a sheet, a screen or a foil which extends substantially parallel to gas separator plate surfaces and which electrically connects each of the plurality of first fillers to each of the plurality of second fillers.

5. The interconnect of claim 3, wherein the interconnecting body comprises a platelet, a strip or a wire which electrically connects each of respective first fillers to a single respective second filler.

6. The interconnect of claim 2, further comprising:
a third separator plate ceramic layer, wherein the second separator plate ceramic layer is located between the first and the third separator plate ceramic layers;
a plurality of third vias extending through the third separator plate ceramic layer but not through the first or second separator plate ceramic layers, wherein the third vias are offset from the second vias;
a plurality of electrically conductive third fillers located in the plurality of third vias, wherein each of the plurality of third fillers is electrically connected to at least one second filler; and
a second electrically conductive interconnecting body located between the second separator plate ceramic layer and the third separator plate ceramic layer, such that the second interconnecting body contacts at least one second filler and at least one third filler to electrically connect at least one second filler to at least one third filler.

7. The interconnect of claim 1, wherein:
the gas separator plate comprises a first major surface and a second major surface separated in the separator plate thickness direction;
the separator plate ceramic layers are stacked in the separator plate thickness direction;
the first fillers are exposed below, in or over the first major surface of the separator plate; and
the second fillers are exposed below, in or over the second major surface of the separator plate.

8. The interconnect of claim 7, further comprising gas flow grooves located in the first and the second major surfaces of the separator plate.

9. A solid oxide fuel cell stack, comprising:
a plurality of interconnects of claim 1;
a plurality of solid oxide fuel cells.

10. The stack of claim 9, wherein:
each solid oxide fuel cell comprises a plate shaped fuel cell comprising a ceramic electrolyte, an anode located on a first surface of the electrolyte and a cathode located on a second surface of the electrolyte;
each interconnect is located between adjacent fuel cells in the stack;
each first filler in each interconnect is electrically connected to an adjacent cathode of a first adjacent fuel cell; and
each second filler in each interconnect is electrically connected to an adjacent anode of a second adjacent fuel cell, such that each interconnect electrically connects an anode of a first fuel cell and a cathode of an adjacent second fuel cell.

11. The stack of claim 10, wherein the ceramic gas separator plate comprises ceramic material layers having a coefficient of thermal expansion which is about one percent or less different from a coefficient of thermal expansion of the ceramic electrolyte material of the fuel cells.

12. The stack of claim 11, wherein:
the electrolyte comprises yttria stabilized zirconia;
the ceramic gas separator plate comprises a blend of alumina and yttria stabilized zirconia;
the first and second fillers and the interconnecting body comprise materials selected from a group consisting of at least one of strontium doped lanthanum manganite, strontium doped lanthanum chromite, silver palladium alloys, chromia forming metals, and platinum.

13. An interconnect for a solid oxide fuel cell, comprising:
a non-ionically and non-electrically conductive ceramic gas separator plate comprising opposing major surfaces;
an electrically conductive interconnecting body located inside the ceramic gas separator plate;
a plurality of first vias which extend from the first major surface of the ceramic gas separator plate up to the interconnecting body;
a plurality of second vias which extend from the second major surface of the ceramic gas separator plate up to the interconnecting body, wherein the second vias are offset from the first vias;
a plurality of electrically conductive first fillers located in the plurality of first vias, wherein the first fillers are exposed below, in or over the first major surface of the gas separator plate and the first fillers are located in electrical contact with the interconnecting body; and
a plurality of electrically conductive second fillers located in the plurality of second vias, wherein the second fillers are exposed below, in or over the second major surface of the gas separator plate and the second fillers are located in electrical contact with the interconnecting body.

14. The interconnect of claim 13, wherein the interconnecting body is selected from a group consisting of a layer, a sheet, a screen, a foil, a platelet, a strip, a wire or an expanded metal.

15. The interconnect of claim 14, wherein the interconnecting body comprises a layer, a sheet, a screen or a foil which extends substantially parallel the first and the second gas separator plate surfaces and which electrically connects each of the plurality of first fillers to each of the plurality of second fillers.

16. The interconnect of claim 14, wherein the interconnecting body comprises a platelet, a strip or a wire which electrically connects each of respective first fillers to a single respective second filler.

17. The interconnect of claim 13, wherein:
the ceramic gas separator plate comprises at least two ceramic layers;
the first vias are located in a first ceramic layer;
the second vias are located in a second ceramic layer; and
the interconnecting body is located between the first and the second ceramic layers.

18. The interconnect of claim 13, wherein the ceramic gas separator plate comprises at least three ceramic layers.

19. The interconnect of claim 13, further comprising gas flow grooves located in the first and the second major surfaces of the separator plate.

20. A solid oxide fuel cell stack, comprising:
a plurality of interconnects of claim 13;
a plurality of solid oxide fuel cells.

21. The stack of claim 20, wherein:
each solid oxide fuel cell comprises a plate shaped fuel cell comprising a ceramic electrolyte, an anode located on a first surface of the electrolyte and a cathode located on a second surface of the electrolyte;
each interconnect is located between adjacent fuel cells in the stack;
each first filler in each interconnect is electrically connected to an adjacent cathode of a first adjacent fuel cell; and
each second filler in each interconnect is electrically connected to an adjacent anode of a second adjacent fuel cell, such that each interconnect electrically connects an anode of a first fuel cell and a cathode of an adjacent second fuel cell.

22. The stack of claim 21, wherein the ceramic gas separator plate comprises a ceramic material having a coefficient of thermal expansion which is about one percent or less different from a coefficient of thermal expansion of the ceramic electrolyte material of the fuel cells.

23. The stack of claim 22, wherein:
the electrolyte comprises yttria stabilized zirconia;
the ceramic gas separator plate comprises a blend of alumina and yttria stabilized zirconia;
the first and second fillers and the interconnecting body comprise materials selected from a group consisting of at least one of strontium doped lanthanum manganite, strontium doped lanthanum chromite, silver palladium alloys, chromia forming metals, and platinum.

24. A method of making an interconnect for a solid oxide fuel cell, comprising:
providing at least two non-ionically and non-electrically conductive ceramic layers;
forming a plurality of first vias extending through the first ceramic layer;
forming a plurality of second vias extending through the second ceramic layer;
laminating the first ceramic layer and the second ceramic layer to form a ceramic gas separator plate, wherein the first vias are offset from the second vias in the laminated layers;
forming a plurality of electrically conductive first fillers in the plurality of first vias; and
forming a plurality of electrically conductive second fillers in the plurality of second vias, such that each of the plurality of first fillers is electrically connected to at least one second filler.

25. The method of claim 24, further comprising:
forming an electrically conductive interconnecting body on at least one of the first ceramic layer and the second ceramic layer prior to laminating the first ceramic layer and the second ceramic layer; and
laminating the first ceramic layer and the second ceramic layer such that the interconnecting body is located between the first and the second ceramic layers.

26. The method of claim 25, wherein:
the step of forming the interconnecting body comprises forming the interconnecting body on a surface of the first or the second unsintered ceramic layer;
the step of laminating the first and the second ceramic layers comprises laminating unsintered first and second ceramic layers after the step of forming the interconnecting body;
the step of forming the first vias comprises forming the first vias in the first unsintered ceramic layer;
the step of forming the second vias comprises forming the second vias in the second unsintered ceramic layer; and
the steps of forming the first and the second fillers comprising forming the fillers such that the interconnecting body contacts at least one first filler and at least one second filler to electrically connect at least one first filler to at least one second filler.

27. The method of claim 25, further comprising:
sintering the laminated first and second ceramic layers to form a sintered ceramic gas separator plate;
filling the first vias with the first fillers after the step of sintering; and
filling the second vias with the second fillers after the step of sintering.

28. The method of claim 24, wherein the interconnecting body comprises a layer, a sheet, a screen, a foil, a platelet, a strip, a wire or an expanded metal.

29. The method of claim 28, wherein the interconnecting body comprises a layer, a sheet, a screen or a foil which electrically connects each of the plurality of first fillers to each of the plurality of second fillers.

30. The method of claim 28, wherein the interconnecting body comprises a platelet, a strip or a wire which electrically connects each of respective first fillers to a single respective second filler.

31. The method of claim 25, further comprising:
forming a third ceramic layer;
forming plurality of third vias extending through the third ceramic layer;
forming a second electrically conductive interconnecting body on at least one of the second and the third ceramic layers;
laminating the perforated third ceramic layer with the first and the second ceramic layers, wherein:
the second ceramic layer is located between the first and the third ceramic layers;
the second interconnecting body is located between the second and the third ceramic layers; and
the third vias are offset from the second vias; and
forming a plurality of electrically conductive third fillers located in the plurality of third vias, wherein each of the plurality of third fillers is contacts the second interconnecting body.

32. The method of claim 24, further comprising forming gas flow grooves in the first and the second ceramic layers such that the gas flow grooves are located in the first and the second major surfaces of the laminated gas separator plate.

33. A method of making solid oxide fuel cell stack, comprising:
providing a plurality of solid oxide fuel cells; and
providing one of a plurality of interconnects made by the method of claim 24 between adjacent solid oxide fuel cells.

34. The method of claim 33, wherein:
each solid oxide fuel cell comprises a plate shaped fuel cell comprising a ceramic electrolyte, an anode located on a first surface of the electrolyte and a cathode located on a second surface of the electrolyte;
each interconnect is located between adjacent fuel cells in the stack;
each first filler in each interconnect is electrically connected to an adjacent cathode of a first adjacent fuel cell; and
each second filler in each interconnect is electrically connected to an adjacent anode of a second adjacent fuel cell, such that each interconnect electrically connects an anode of a first fuel cell and a cathode of an adjacent second fuel cell.

35. The method of claim 34, wherein the ceramic gas separator plate comprises ceramic material layers having a coefficient of thermal expansion which is about one percent or less different from a coefficient of thermal expansion of the ceramic electrolyte material of the fuel cells.

36. The method of claim 35, wherein:
the electrolyte comprises yttria stabilized zirconia;
the ceramic gas separator plate comprises a blend of alumina and yttria stabilized zirconia;
the first and second fillers and the interconnecting body comprise materials selected from a group consisting of at least one of strontium doped lanthanum manganite, strontium doped lanthanum chromite, silver palladium alloys, chromia forming metals, and platinum.
